(19) United States
(12) Patent Application Publication
(10) Pub. No.: US 2015/0379898 A1
(43) Pub. Date: Dec. 31, 2015

(54) THERMODYNAMIC MODEL OF A NERVOUS SYSTEM

(71) Applicant: Joel Steven Goldberg, Hillsborough, NC (US)

(72) Inventor: Joel Steven Goldberg, Hillsborough, NC (US)

(21) Appl. No.: 14/844,202

(22) Filed: Sep. 3, 2015

(51) Int. Cl. G09B 23/28

(52) U.S. Cl. CPC G09B 23/28

(57) ABSTRACT

A thermodynamic model of the nervous system was designed consisting of a vessel, an insulated oscillating chemical reaction (Belouvsa-Zhabotinsky reaction), platinum and graphite electrodes, a solenoid surrounding the vessel, an on-off DC generator and an oscilloscope connected to the electrodes. This thermodynamic model is an open, autocatalytic, chaotic system not at equilibrium that reflects the nature of a nervous system. A changing electromagnetic field has been shown to influence the internal energy of the system by performing work on the system as demonstrated by changes in the oscillating waves of the system. This model can be incorporated into other models of a nervous system that do not address influences from the electromagnetic surroundings. This model may explain the clinical findings that geomagnetic fields, Schumann frequencies or other sources of changing electromagnetic fields can produce mood changes in susceptible individuals some of whom may suffer from symptoms of depression, mania or chronic pain. In some instances, changing the electromagnetic fields of the earth at particular locations may have beneficial effects.

### CROSS-REFERENCES TO RELATED APPLICATIONS

None

### FEDERALLY FUNDED RESEARCH

Not applicable

### BACKGROUND OF THE INVENTION

In 1824, Sadi Carnot described the theoretical efficiencies of a heat engine. At the time, he was well aware of gravitational and frictional forces, the elements of carbon, hydrogen and oxygen and the 1813 demonstration of the combustion of a diamond by Sir Humphry Davy. Realizing the complexity of a heat engine, he viewed it as a system, influenced by its surroundings, with internal energies from heat and work. In a similar manner, I have described a thermodynamic model of a nervous system.

Most neuroscientists agree that modeling of a nervous system will be the pathway to a better understanding of the brain and mind. Present models include data from neuroanatomical stimulation, biochemical imaging and mapping neural connectomes. It has been proposed that information from these models will elucidate the essence of nervous system activity.

Lacking in the present models of a nervous system are thermodynamic effects of the electromagnetic surroundings on this system. The nervous system, a thermodynamically open electrochemical system in which energy and matter flow between system and surroundings, can be described in terms of state functions including, temperature, pressure, molar quantities, enthalpy and entropy. The internal energy of the nervous system can be described by:

U=w+q+ΔE
U=internal energy
w=total work on the system or by the system
q=total heat added or subtracted from the system
ΔE=mass and energy transfers to and from an open system=flow work

wₜₒₜₐₗ=w_{mechanical}+w_{electrochemical potential}+w_{flow work}

In a nervous system under relatively constant pressure and constant temperature w_{mechanical} and q equal zero and w_{flow work} may be small and cannot be measured.
The electrochemical potential of the system is:

$${\sum }_{i = 1}^{c} {μ}_{i} {dN}_{i} + {\sum }_{j = 1}^{c} {Φ}_{j} {Z}_{j} {FdN}_{j}$$

C=number components or species of the system
N=number of moles of each constituent species
ith species having Ni moles
jth species having Nj moles
μᵢ=chemical potential of each component
Φ=electrostatic potential
Z=valency
F=Faraday constant

Work from an external static magnetic field (w_{B}) on charged and non-charged particles within the system equals zero. There are two other possible sources of work related to the electrochemical potential. Work from an electric field (wₑ) and work from the Poynting vector, (w_{e×b}) or S=1/μ₀E×B.

Even small changes in the electromagnetic surroundings may have a significant effect on the function of the system since there is good evidence that the activity of a nervous system is chaotic. There is clinical evidence that symptoms such as depression, mania and chronic pain are correlated with geomagnetic activity independent of diurnal variation.(Roecklein, Rohan, & Postolache, 2010; Saps et al., 2008) A model of a nervous system that does not include the changing electromagnetic fields in the surroundings is not complete.

The most studied oscillating chemical reaction is the Belouvsa-Zhabotinsky (B-Z) reaction. This oscillating chemical reaction produces electrical potentials very similar to the action potentials within a nervous system. These potentials are unlike those produced by alternating current from a generator or direct current from a fuel cell or battery. From the oxidation of malonic acid, the B-Z reaction also produces carbon dioxide similar to the oxidation of glucose in the Krebs cycle of a nervous system. The B-Z reaction can also proceed at constant temperature similar to that of the nervous system in warm blooded mammals. This nonlinear deterministic reaction models the chaos seen in the brain's electrical activity.(Sarbadhikari & Chakrabarty, 2001) Although not identical to the nervous system, the attributes found in the B-Z reaction, when viewed from a thermodynamic perspective closely approximate the energy transfers that occur in a nervous system.

The B-Z reaction produces electromagnetic waves of low frequency ( 1/60 Hertz) that can be observed when electrodes are placed in the reaction and connected to an oscilloscope with DC coupling. Until the oscillating chemical reaction is complete, the B-Z oscillating chemical reaction is autocatalytic, not at equilibrium, and has properties of a chaotic system. The reagents of the B-Z reaction consist of sodium bromide, malonic acid, sulfuric acid, and ferroin indicator. The ferroin indicator produces a color change from red to purple when vigorously stirred usually with a magnetic stirring bar. The proposed mechanism of this reaction has been described by Field, Koros and Noyes (Field, Noyes, & Koros, 1972)

This invention demonstrates that a thermodynamic model of a nervous system, as simulated by the B-Z reaction, is not complete unless work performed on the system by the changing electromagnetic surroundings is considered.

### DESCRIPTION OF THE DRAWINGS

FIG. 1 shows the B-Z reaction oscillatory changes induced by a changing electromagnetic field. Label 1 shows the y axis that is the amplitude of the oscillating potential generated by the B-Z reaction, label 2 is the dampened wave, label 3 is the time at which a changing magnetic field from the solenoid is initiated, label 4 shows the regeneration of oscillations from work on the system.

FIG. 2 shows the B-Z reaction oscillatory changes induced by a changing electromagnetic field. Label 1 shows the amplitude of the oscillating waves generated by the B-Z reaction, label 2 is the x axis or time, label 3 is the time at which a changing electromagnetic field from the solenoid was initiated, label 4 shows the changes in waveform after work has been done on the system by a changing electromagnetic field.

FIG. 3 shows the experimental apparatus used to model a nervous system. Label 1 is a glass vessel, label 2 is a solenoid, label 3 is a platinum electrode, label 4 is a graphite electrode, label 5 is a hot plate, label 6 is air space insulation, label 7 is aluminum foil insulation, label 8 is a thermometer, label 9 is a DC power source, label 10 is a switch, label 11 are the reagents and products of the B-Z reaction, and label 12 is an oscilloscope.

### DETAILED DECRIPTION OF THE INVENTION

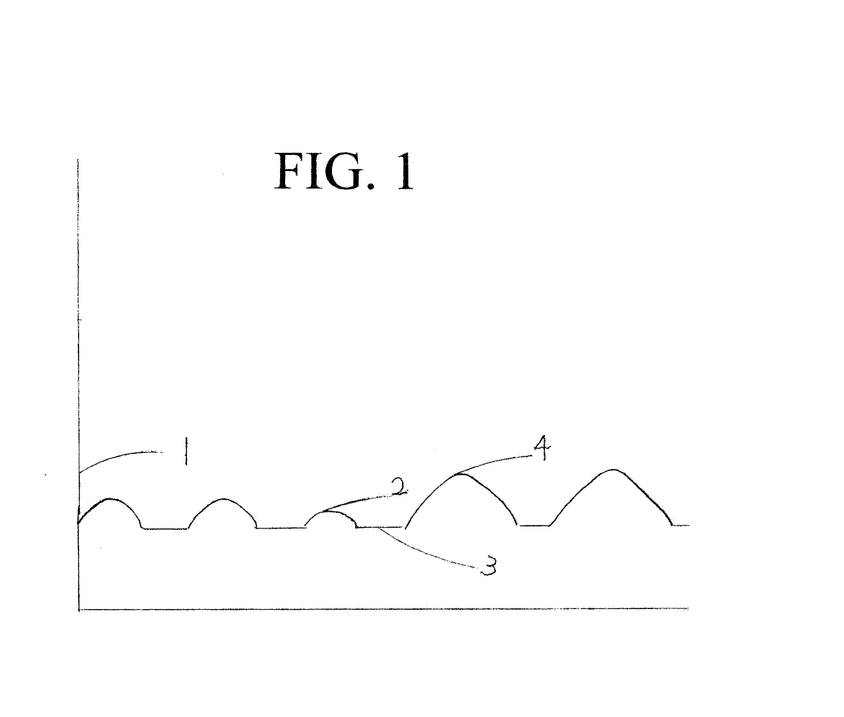

Oscillating chemical systems, such as the B-Z reaction, produced electrical potentials very similar to the action potentials within a nervous system. These potentials are unlike those produced by alternating current with polarity from a generator or direct current from a fuel cell or battery. (FIGS. 1&2) The B-Z reaction produces electromagnetic waves of low frequency ( 1/60 Hertz) that can be observed when electrodes are placed in the reaction and connected to an oscilloscope with DC coupling. Until the B-Z reaction is complete, this oscillating chemical reaction is autocatalytic, not at equilibrium, and has properties of a chaotic system. These characteristics of the B-Z reaction provide a thermodynamic model of the nervous system.

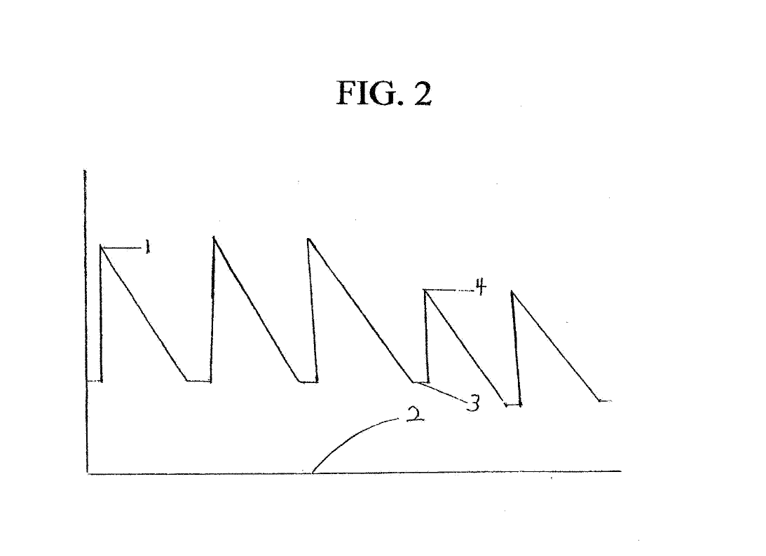

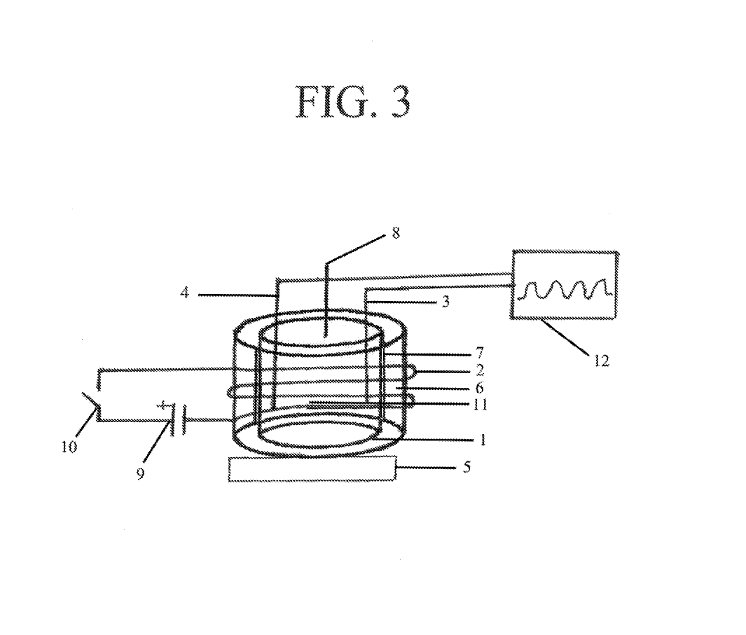

When platinum and graphite electrodes are immersed in a heated solution at 30° C. of 0.2M sodium bromate, 0.2M malonic acid, 0.005M ferroin solution and 0.3M sulfuric acid (reagents of the B-Z reaction) an oscillating chemical reaction is produced that can be monitored with an oscilloscope. (FIGS. 1 & 2) In previous demonstrations of the B-Z reaction, energy from a magnetic stirrer has been required to propagate the reaction, but in this invention it was discovered that the magnetic stirrer could be replaced with heat generated from a hot plate. When the electrodes are connected to an oscilloscope with DC coupling, oscillating waves with amplitudes of 0.5-1 mV and frequency of approximately 1/60 Hertz are produced. (FIGS. 2&3) This system is surrounded by aluminum foil to reflect radiant heat, air insulation and a copper solenoid. (FIG. 3) The solenoid is connected to a changing on-off DC power source at 2 Hertz for 60 seconds producing changing electromagnetic fields. In this invention it was discovered that as the B-Z reaction approached equilibrium with dampening of oscillating waves, addition of a changing electromagnetic field can restore the oscillations demonstrating that work was done on the system. (FIG. 1) It was also discovered that a changing electromagnetic field can alter the contour of oscillating waves, (FIG. 2), again confirming that work was performed on the system. This invention demonstrates that a thermodynamic model of a nervous system can change its oscillatory trajectory from the work of a surrounding changing electromagnetic field. Theory predicts that his should be the case as the changing electromagnetic field with the forces from the induced electric field can perform work on the system or the cross product of the electric and magnetic fields, E×B, known as the Poynting vector can perform work on the system. Heat effects from the solenoid were excluded by air insulation and wrapping the vessel with aluminum foil. The experiments were performed at constant temperature monitored with a thermometer. Using the same apparatus any work from the changing electromagnetic fields on the paramagnetic reagent, ferroin, was excluded and this experiment also served as a control.

The B-Z reaction was studied under four conditions:
1. A changing electromagnetic field produced by the solenoid did work on the system as demonstrated by return of oscillations or changes in the waveform (FIGS. 1&2)
2. A static magnetic field produced by current in the solenoid did not change the oscillations and added no heat to the system.
3. A static electric field produced from plate capacitors did not change the oscillations and added no heat to the system.
4. A changing electric field produced from plate capacitors did not change the oscillations and added no heat to the system.

### EXPERIMENTAL SECTION

A vessel containing the reagents of the B-Z reaction with platinum and graphite electrodes, thermometer, thermally isolated with aluminum foil and air insulation and surrounded by a copper solenoid of 100 turns and length 4 cm was positioned on a hot plate. The electrodes were connected to an oscilloscope with DC coupling at 0.5 mV per unit detection and with a sweep speed of 48 seconds. The solenoid was connected to a DC power source with a switch that was manually turned on and off at a frequency of 2 Hertz for 1 minute with a maximum current of 1 or 10 amperes for each experiment. (FIG. 3)

Calculations for I=10 A
L=0.04 m>>R=0.02
L=length of solenoid in meters (m)=0.04 m
R=radius of solenoid=0.02 m
B=magnetic flux density inside solenoid=μμ₀NI/L=T=kg·s⁻²A⁻¹
μ₀=1.25×10⁻⁶ m·kg·s⁻²·A⁻²
N=number of turns=100
I=current flow=10 A
B=magnetic flux density inside solenoid=3.1×10⁻² T=3.1×10⁻² kg·s⁻²A⁻¹
Φ=magnetic flux=B×area=Bπr²
E_{induced}=−dΦ/dt
E_{induced}=d B π r²/dt
dB/dt˜ΔB/Δt (dB/dt is not continuous)
ΔB=3.1×10⁻² kg·s⁻²A⁻¹
Δt=0.5 s
r²=0.0004 m²
E_{induced}˜7.7×10⁻⁵V/m˜7.7×10⁻⁵ m·kg·s⁻³A⁻¹
Poynting vector S when I equals 10 A is ˜1/μ₀ (E×B)=(8×10⁵)(7.7×10⁻⁵)(3.1×10⁻²)˜1.9 Wm⁻² or 1.9 kg·s⁻³

As the oscillations dampen from the B-Z reaction, a changing electromagnetic field was initiated by manually switching on-off at frequencies of 2 Hertz for 60 seconds with a DC power source between 1 or 10 amperes. The changing electromagnetic field increased the amplitude of the dampened waves. (FIG. 1) The effects on the oscillations increased as the current to the solenoid increased when temperature remained constant. Heat effects on the oscillatory waves were synergistic when added to the changing electromagnetic field. Also, it was possible to demonstrate waveform perturbations from a changing electromagnetic field. (FIG. 2) A static magnetic field produced by the solenoid with DC currents of 1 or 10 amperes did not change oscillations.

A zinc plate capacitor covering two glass parallel plates 0.20 m×0.26 m separated by a distance of 0.005 m that forms a cell containing the B-Z reaction was charged with 640 V. Platinum and graphite electrodes immersed in the reaction mixture were connected to an oscilloscope with DC coupling.
C=εcA/d
C=capacitance
k=dielectric constant for glass=7
ε₀=8.85×10⁻¹² F/m
ε=ε₀×k=6.2×10⁻¹¹ F/m
A=area=5.2×10⁻² m²
d=0.005 m=5×10⁻³m
C=6.4×10⁻¹° F.
C V=Q
V=6.4×10² V
Q=4×10⁻⁷ C
E=Q/Cd
E=1.2×10⁻⁴V/m or 1.2×10⁻⁴ m·kg·s⁻³·A⁻¹

### Benefits to Society

This invention demonstrates that a changing electromagnetic field can influence the electrochemistry of a thermodynamic model of a nervous system. The changing electromagnetic field can perform work on the system and can affect an oscillating chemical reaction that simulates brain chemistry. Many disease states such as depression, mania and chronic pain have been linked to changes in the earth's geomagnetic field exclusive of diurnal changes.(Roecklein, et al., 2010) In susceptible individuals increasing psychiatric medications during these times of the year has been suggested and this invention provides evidence why geomagnetic changes could produce changing symptoms.(Roecklein, et al., 2010)

Transcranial magnetic stimulation and electroconvulsive therapies have been shown to be efficacious for the treatment of depression. Transcranial magnetic stimulation has been shown to alter the EEG signal that is in agreement with the findings of this invention.(Li, Yin, & Huo, 2007)

This invention does not address whether exposure to a changing electromagnetic field will be beneficial or deleterious. Although changes in brain chemistry from a changing electromagnetic field may be small compare to those produced by medications, small changes may produce profound changes in the trajectory of a chaotic nervous system.

From a public health perspective, there may exist electromagnetic fields that are beneficial or deleterious. Whether exposure to electromagnetic fields from cell phones, high voltage wires and microwave has effects on the brain is still subject to much debate. (Hossmann & Hermann, 2003) However, man made changes of the earth's electromagnetic fields is possible as has been demonstrated by the High Frequency Active Auroral Research Program (HAARP) project in which electromagnetic radiation was broadcast into the ionosphere.(Fujimaru & Moore, 2011) This invention shows that a thermodynamic model of the brain's chaotic oscillating chemistry can be influenced by external changing electromagnetic fields. In nature, changing electromagnetic fields occur from geomagnetic fields, Schumann resonance signals and solar activities.(Berk, Dodd, & Henry, 2006; Cherry, 2003) Since behavior relates to brain chemistry, speculating in the future, modifying the earth's electromagnetic fields at particular locations could be beneficial.

### REFERENCES

Berk, M., Dodd, S., & Henry, M. (2006). Do ambient electromagnetic fields affect behaviour? A demonstration of the relationship between geomagnetic storm activity and suicide. Bioelectromagnetics, 27(2), 151-155.
Cherry, N. J. (2003). Human intelligence: the brain, an electromagnetic system synchronised by the Schumann Resonance signal. Med Hypotheses, 60(6), 843-844.
Field, R. J., Noyes, R. M., & Koros, E. (1972). Oscillations in Chemical Systems .2. Thorough Analysis of Temporal Oscillation in Bromate-Cerium-Malonic Acid System. Journal of the American Chemical Society, 94(25), 8649-&.
Fujimaru, S., & Moore, R. C. (2011). Analysis of time-of-arrival observations performed during ELF/VLF wave generation experiments at HAARP. Radio Science, 46.
Hossmann, K. A., & Hermann, D. M. (2003). Effects of electromagnetic radiation of mobile phones on the central nervous system. Bioelectromagnetics, 24(1), 49-62.
Li, L. X., Yin, Z. G., & Huo, X. L. (2007). The influence of low-frequency rTMS on EEG of rats. Neuroscience Letters, 412(2), 143-147.
Roecklein, K. A., Rohan, K. J., & Postolache, T. T. (2010). Is seasonal affective disorder a bipolar variant? Curr Psychiatr, 9(2), 42-54.
Saps, M., Blank, C., Khan, S., Seshadri, R., Marshall, B., Bass, L., et al. (2008). Seasonal variation in the presentation of abdominal pain. J Pediatr Gastroenterol Nutr, 46(3), 279-284.
Sarbadhikari, S. N., & Chakrabarty, K. (2001). Chaos in the brain: a short review alluding to epilepsy, depression, exercise and lateralization. Med Eng Phys, 23(7), 445-455.

Having described my invention, I claim:

1. A model of a nervous system that includes the influences of the electromagnetic surroundings on the model.

2. A thermodynamic model of a nervous system that includes the influences of the electromagnetic surroundings on the model.
